(19) United States
(12) Patent Application Publication
(10) Pub. No.: US 2011/0024453 A1
(43) Pub. Date: Feb. 3, 2011

(54) Pouring Device

(76) Inventor: Erez Fleisher, Tel-Aviv (IL)

Correspondence Address: The Law Office of Michael E. Kondoudis, 888 16th Street, N.W., Suite 800, Washington, DC, 20006, US

(21) Appl. No.: 12/511,109

(22) Filed: Jul. 29, 2009

(51) Int. Cl. B65D 5/66; B67D 3/00

(52) U.S. Cl. 222/113; 222/481.5

(57) ABSTRACT

A pouring device comprising a pourer and a cover. One pourer is attached to an orifice of a bottle having a vertical axis, and has an opening. One cover is attached to the pourer and has two states comprising a closed state in which the cover blocks the opening and an open state in which the opening is unblocked. The pourer is configured to allow pouring the fluid out of the bottle and through the opening sideward in respect to the vertical axis of the bottle.

### BACKGROUND

1. Technical Field

The present invention relates to the field of drinking appliances, and more particularly, to a pouring device.

2. Discussion of Related Art

Pouring devices are used to pour drinks in a comfortable and impressive manner. Pouring devices allow carrying out tricks and jugglery. Yet pouring devices have several disadvantages, including spilling, a low level of hygiene, and difficulty to operate with them in a clean and quick manner in the dark.

U.S. Patent Publication No. 2008029547, which is incorporated herein by reference in its entirety, discloses a liquid dispenser including a cover connecting to the opening of a container and a main body connecting to the cover. The main body includes a chamber in communication with the cover and a liquid outlet for liquid discharge, wherein a liquid output device is arranged in the chamber, a button is arranged on the main body for controlling the action of the liquid output device, a one-way valve is arranged in the liquid output device for adjusting the open/close state of a liquid output passage.

U.S. Pat. No. 5,072,861, which is incorporated herein by reference in its entirety, discloses a liquid dispensing controller including a controlling unit and a press device whereby the liquid will not flow out of a bottle even if the bottle is overturned and may be controlled in flow rate. Further, the liquid dispensing controller is adapted to various kinds of cups thereby preventing liquid from spilling everywhere.

### BRIEF SUMMARY

Embodiments of the present invention provide a pouring device comprising a pourer and a cover. One pourer is attached to an orifice of a bottle having a vertical axis, and has an opening. One cover is attached to the pourer and has two states comprising a closed state in which the cover blocks the opening and an open state in which the opening is unblocked. The pourer is configured to allow pouring the fluid out of the bottle and through the opening sideward in respect to the vertical axis of the bottle.

Embodiments of the present invention provide a pouring device comprising a pourer and a cover. One pourer is attached to an orifice of a bottle having a vertical axis. The pourer has an opening, and the pourer is configured to allow pouring the fluid out of the bottle and through the opening sideward in respect to the vertical axis of the bottle. The pourer has an air way with an air hole, and comprises lighting means. The cover is attached to the pourer with a spring. The cover has two states comprising a closed state in which the cover blocks the opening and an open state in which the opening is unblocked. Pushing the cover is carried out against the spring and results in the open state. The cover comprises an activation area arranged to allow changing between the two states of the cover. The air way is arranged to allow air enter the bottle and replace poured fluid. The air hole is blocked in the closed state and free at the open state. The lighting means are activated in the open state and not active in the closed state.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1A, 1B, 1C, 2A, 2B and 2C are schematic illustrations of a pouring device, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

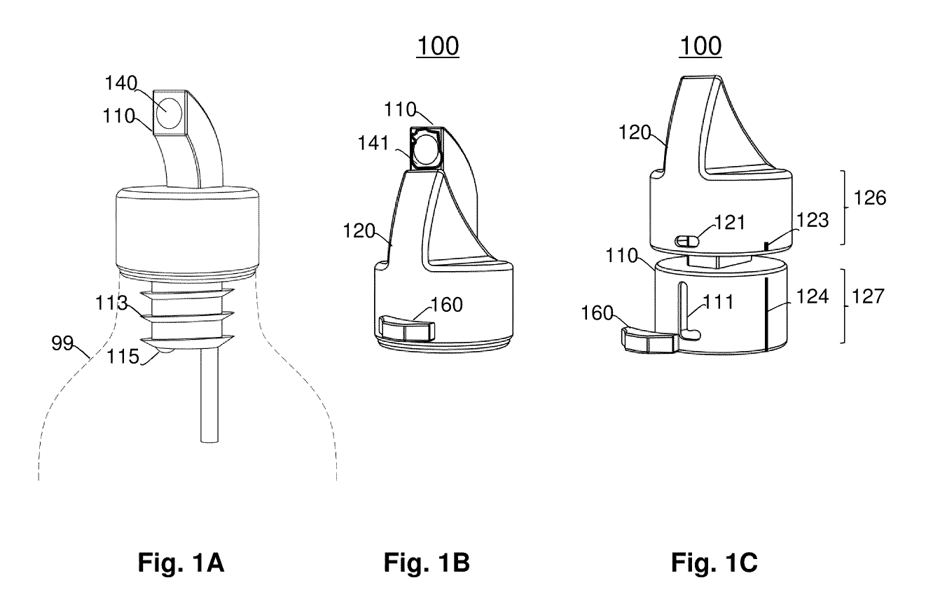

FIGS. 1A, 1B, 1C are schematic illustrations of a pouring device 100, according to some embodiments of the invention. FIG. 1A illustrates a pourer 110 comprising an opening 140, is attached to an orifice (not shown) of a bottle 99, and is arranged to allow flowing of a fluid out of bottle 99 and through opening 140. Opening 140 is configured to allow pouring the fluid sideward in respect to the vertical axis of bottle 99. Pourer 110 may comprise inner attachment means 113 arranged to seal the orifice by keeping a tight contact with the inner side of bottle 99. Pourer 110 may comprise lighting means 115, such as a LED, for illuminating bottle 99 from within. FIGS. 1B and 1C illustrate pouring device 100 comprising pourer 110 and a cover 120. Cover 120 is operably attachable to pourer 110 and exhibits two states: an open state and a closed state. FIG. 1B illustrates an open state in which opening 140 is free and unblocked by cover 120. In the closed state (not shown) cover 120 blocks opening 140. FIG. 1C is an exploded view illustration of cover 120. Cover 120 may comprise a lock 160 arranged to keep pourer 110 in the open state. For example, lock 160 may fixate cover 120 in the open state by sliding a pin (not shown) via a slit 121 in cover 120 and into a sideward bending groove 111 in pourer 110, wherein the sideward position prohibits unintended movement of the pin. Lock 160 may allow the user to work with pouring device 100 at a constantly open state e.g. when bottle 99 is used frequently.

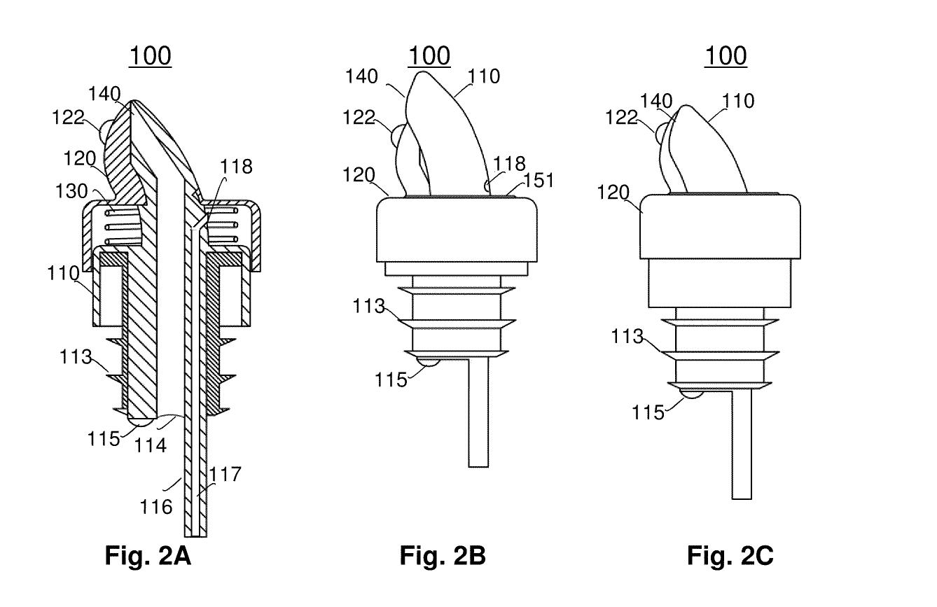

FIGS. 2A, 2B, 2C are schematic illustrations of pouring device 100, according to some embodiments of the invention. FIG. 2A is cross section view of pouring device 100 in a closed state, FIG. 2B is a side view of pouring device 100 in an open state, and FIG. 2C is a side view of pouring device 100 in a closed state. FIG. 2A illustrates pouring device 100 comprising pourer 110 and cover 120. Cover 120 is operably attachable to pourer 110 and exhibits two states: an open state (FIG. 2B) and a closed state (FIG. 2A, FIG. 2C). Pourer 110 comprises an opening 140, and is arranged to allow flowing of a fluid out of bottle 99, through a cannula 114 in pourer 110 and through opening 140.

According to some embodiments of the invention, pourer 110 may comprise a protrusion 116 for directing the fluid into cannula 114 and through pourer 110 to opening 140. An airway 117 may allow air movement through an air hole 118. In a closed state, pouring device 100 may be sealed and arranged to act as a bottle cover or cork, operatively capping the bottle and keeping hygienic requirements and to prevent spillage and evaporation from the bottle.

According to some embodiments of the invention, opening 140 is configured to allow pouring the fluid sideward in respect to the vertical axis of bottle 99. Pourer 110 may comprise inner attachment means 113 arranged to seal the orifice of bottle 99 by keeping a tight contact with the inner side of bottle 99. Pourer 110 may comprise lighting means 115, such as a LED, for illuminating bottle 99 from within. Cover 120 may also comprise lighting means 122 such as LED's, to allow using the pouring device in dark surroundings. Lighting means 122 may be placed such as to allow illuminating the working surface, bottle racks or the content of the bottle. Lighting means 122 may be activated upon pushing cover 120. In some embodiments, lighting means 115 may illuminate the interior of bottle 99 while lighting means 122 may illuminate a glass to which the fluid is poured, or the working surface. Pourer 110 may further comprise an inscription that may be illuminated by lighting means 122 as well. In embodiments, a part of pourer 110 may be transparent, and lighting means 122 may illuminate through pourer 110. Pourer 110 may further comprise an engraving that may illuminated by lighting means 122. Either the inscription or the engraving may be used to convey information relating to the content of bottle 99, or serve to bear commercial advertisements. Lighting means 115 and 122 are connected to appropriate electronic circuits (not shown) coupling the opening of cover 120 with the activation of lighting means 115 and 122. The electronic circuits are protected from the fluid, e.g., they may be embedded in pourer 110 or covered with an isolating material.

According to some embodiments of the invention, air hole 118 is blocked in the closed state and free at the open state. In this way, in a closed state pouring device 100 seals bottle 99. According to some embodiments of the invention, a lubricating substance 141 (FIG. 1) such as silicone or rubber may be applied to the surrounding or opening 140, such that pouring device 100 is sealed in a closed state. Lubricating substance 141 may allow a smooth sliding of cover 120 over pourer 110 during the opening or closing cover 120. Lighting means 115 and 122 may be activated in the open state and not active in the closed state.

According to some embodiments of the invention, cover 120 may contact pourer 110 by means of a spring 130 arranged to push cover 120 from the open state to the closed state. Cover 120 may be opened by pushing cover 120 against spring 130. Pushing cover 120 further exposes air hole 118 that allows entrance of ambient air into bottle 99 through airway 117 to replace the poured fluid. Transition to the open state may be enabled by pushing cover 120 at a predefined activation area 151. Activation area 151 may be arranged to allow changing between the two states of cover 120. Pushing cover 120 may activate lighting means 115 and/or lighting means 122. According to some embodiments of the invention, pushing cover 120 does not generate any tilting of pouring device 100 or pourer 110.

According to some embodiments of the invention, activation area 151 may be located in relation to parameters such as the practice of pouring, handedness and techniques of different users. For example, a portion of activation area 151 may be located at the back of cover 120, where a controlling finger is often placed. A portion of activation area 151 may be located on pourer 110 such, that pressing activation area 150 may mechanically tilt cover 120 in a predefined angle.

According to some embodiments of the invention, either pourer 110 or cover 120 may comprise transparent parts, located in relation to lighting means 115 and lighting means 122, and arranged to create various light effects. Lighting means 115 and lighting means 122 may be activated upon state change of pouring device 100 from a closed state to an open state, vice versa, or with predefined delay. A transparent part may comprise an inscription, such as label information, and advertisement, etc. For example, pouring device 100 may be made of plastic, and a LED with an inscription may be located on cover 120 or on a plastic strap attached to pouring device 100. As another example, pourer 110 may be at least partly transparent, and lighting means 115 may be arranged to illuminate upon flowing of the fluid through pouring device 100.

According to some embodiments of the invention, pourer 110 may further comprise a flow meter arranged to measure the flow of the fluid through opening 140.

According to some embodiments of the invention, cover 120 is arranged to have a common vertical axis with pourer 110 and move parallel to pourer 110 such that cover 120 does not get inclined in respect to the axis of pourer 110. For example, this may be realized by pourer 110 having at least one groove 124 and cover 120 having at least one notch 123 fitting into respective groove 124 and arranged to guide cover 120 such as to move parallel to pourer 110.

According to some embodiments of the invention, pourer 110 has a basal part 126 and cover 120 has a basal part 127. Both basal parts 126, 127 may be cannular (hollow cylinders, tube-like) with a common axis. Basal part 127 of the cover 120 may be arranged to tightly enclose basal part 126 of pourer 110 in the open state Basal part 127 may have a somewhat larger radius than basal part 126 such that basal part 127 can be slid upon basal part 126 until they reach a concentric position. Grooves 124 and notches 123 may be arranged such as to guide the sliding movement of cover 120 upon pourer 110.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The descriptions, examples, and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A pouring device comprising:
a pourer having an opening, the pourer is attached to an orifice of a bottle having a vertical axis; and
a cover attached to the pourer and having two states comprising a closed state in which the cover blocks the opening and an open state in which the opening is unblocked,
wherein the pourer is configured to allow pouring fluid out of the bottle and through the opening sideward in respect to the vertical axis of the bottle.

2. The pouring device of claim 1, wherein the cover further comprises an activation area arranged to allow changing between the two states of the cover.

3. The pouring device of claim 1, wherein the cover further comprises a lock arranged to keep the pourer in the open state.

4. The pouring device of claim 1, wherein the pourer further comprises a flow meter arranged to measure the flow of the fluid through the opening.

5. The pouring device of claim 1, wherein the pourer is at least partly transparent, and further comprises a lighting means arranged to illuminate upon flowing of the fluid through the pouring device.

6. The pouring device of claim 5, wherein the cover is at least partly transparent, and further comprises an inscription.

7. The pouring device of claim 1, wherein the pourer further has an air way with an air hole arranged to allow air enter the bottle and replaces poured fluid, and wherein the air hole is blocked in the closed state and free at the open state.

8. The pouring device of claim 1, wherein the cover is attached to the pourer with a spring, and wherein pushing the cover is carried out against the spring and results in the open state.

9. The pouring device of claim 1, wherein the pourer further comprises lighting means that are activated in the open state and not active in the closed state.

10. The pouring device of claim 9, wherein the pourer further comprises at least one electronic circuit arranged to activate the lighting means upon opening of the cover.

11. The pouring device of claim 10, wherein at least one electronic circuit is protected from the fluid.

12. The pouring device of claim 1, wherein the pouring device is sealed in the closed state, wherein the sealed pouring device operatively caps the bottle.

13. The pouring device of claim 12, further comprising a lubricating substance applied around the opening, so as to seal the pouring device in a closed state.

14. The pouring device of claim 1, wherein the cover and the pourer have a common vertical axis and the cover is arranged to move along the common vertical axis.

15. The pouring device of claim 1, wherein both cover and pourer have cannular basal parts with a common axis, and wherein the basal part of the cover is arranged to tightly enclose the basal part of the pourer in the open state.

16. The pouring device of claim 1, wherein the pourer has at least one groove and the cover has at least one notch arranged to fit into the respective groove and guide the movement of the cover along the pourer.

17. A pouring device comprising:
a pourer attached to an orifice of a bottle having a vertical axis having:
an opening, wherein the pourer is configured to allow pouring fluid out of the bottle and through the opening sideward in respect to the vertical axis of the bottle;
an air way with an air hole; and comprising
lighting means, and
a cover attached to the pourer with a spring, the cover having two states comprising a closed state in which the cover blocks the opening and an open state in which the opening is unblocked, wherein pushing the cover is carried out against the spring and results in the open state, the cover comprising an activation area arranged to allow changing between the two states of the cover,
wherein the air way is arranged to allow air enter the bottle and replaces poured fluid, wherein the air hole is blocked in the closed state and free at the open state,
wherein the lighting means are activated in the open state and not active in the closed state, the lighting means controlled by at least one electronic circuit, which is protected from the fluid and arranged to activate the lighting means upon opening of the cover,
wherein both cover and pourer have cannular basal parts with a common axis, and wherein the basal part of the cover is arranged to tightly enclose the basal part of the pourer in the open state, and
wherein the pourer has at least one groove and the cover has at least one notch arranged to fit into the respective groove and guide the movement of the cover along the pourer.
